(19) United States
(12) Patent Application Publication
(10) Pub. No.: US 2024/0362554 A1
(43) Pub. Date: Oct. 31, 2024

(54) TASK WINDOW CREATION AND CONFIGURATION

(71) Applicant: JAMF Software, LLC, Minneapolis, MN (US)

(72) Inventors: Matthew Mitchell, Eau Claire, WI (US); Travis Boettcher, Mondovi, WI (US); Ryan Pinter, Eau Claire, WI (US); Ashley Beard, Lauderdale, MN (US)

(21) Appl. No.: 18/308,421

(22) Filed: Apr. 27, 2023

(51) Int. Cl. G06Q 10/0631; G06F 8/65

(52) U.S. Cl. CPC G06Q 10/06312; G06F 8/65

(57) ABSTRACT

In certain aspects of the present disclosure, a computer-implemented method includes receiving, from a manager device, at least one task availability constraint, wherein the at least one task availability constraint is configured at the manager device. The method includes receiving, from at least one managed device, configured task window settings, wherein the configured task window settings are configured at the at least one managed device based on the at least one task availability constraint. The method includes creating a task window associated with the at least one managed device based on the configured task window settings and the at least one task availability constraint. Systems and machine-readable media are also provided.

### TECHNICAL FIELD

The present disclosure generally relates to mobile devices and management systems, and more specifically relates to task window creation and configuration.

### BACKGROUND

Many organizations manage numerous end user devices that are under their purview. From time to time, the organization may need to deploy tasks, such as maintenance tasks, to be performed on these end user devices. In some instances, these maintenance tasks are disruptive and may require that applications running on the end user device be closed or may require the end user device to restart, as a few examples. Organizations have made efforts to reduce disruption on the end user devices during these deployed tasks, such as by having an administrator set a particular date and time, with no input from the end users, to perform the task during non-peak usage times. While helpful, such scheduling done solely by an administrator may still disrupt end users of the end user devices and does not allow for granularity per end user preference.

The description provided in the background section should not be assumed to be prior art merely because it is mentioned in or associated with the background section. The background section may include information that describes one or more aspects of the subject technology.

### SUMMARY

In particular aspects, the present disclosure provides systems and methods that enable a “manager” or “primary” mobile device to perform selected MDM functions with respect to one or more “managed,” “targeted,” or “secondary” mobile devices. For example, in an educational context, the manager device may be a tablet computer or laptop computer operated by an administrator who schedules deployment of disruptive tasks to managed devices that are managed by a mobile device management service.

According to certain aspects of the present disclosure, a computer-implemented method is provided. The method includes receiving, from a manager device (e.g., a device an administrator uses to access a manager app on the device), at least one task availability constraint, wherein the at least one task availability constraint is configured at the manager device. The method includes receiving, from at least one managed device, configured task window settings, wherein the configured task window settings are configured at the at least one managed device based on the at least one task availability constraint. The method includes creating a task window associated with the at least one managed device based on the configured task window settings and the at least one task availability constraint.

According to other aspects of the present disclosure, a system is provided. The system includes a memory comprising instructions and a processor configured to execute the instructions which, when executed, cause the processor to receive, from a manager device, at least one task availability constraint, wherein the at least one task availability constraint is configured at the manager device. The processor is configured to execute the instructions which, when executed, cause the processor to receive, from at least one managed device, configured task window settings, wherein the configured task window settings are configured at the at least one managed device based on the at least one task availability constraint. The processor is configured to execute the instructions which, when executed, cause the processor to create a task window associated with the at least one managed device based on the configured task window settings and the at least one task availability constraint.

According to other aspects of the present disclosure, a non-transitory machine-readable storage medium comprising machine-readable instructions for causing a processor to execute a method is provided. The method includes receiving, from a manager device, at least one task availability constraint, wherein the at least one task availability constraint is configured at the manager device. The method includes receiving, from at least one managed device, configured task window settings, wherein the configured task window settings are configured at the at least one managed device based on the at least one task availability constraint. The method includes creating a task window associated with the at least one managed device based on the configured task window settings and the at least one task availability constraint.

According to other aspects of the present disclosure, a computer-implemented method is provided. The method includes receiving, from a manager device, a configuration of a calendar service, wherein the configuration of the calendar service is configured at the manager device. The method includes receiving, from the manager device, a dynamic scheduling command associated with the configuration of the calendar service. The method includes receiving, from at least one managed device, a dynamic scheduling selection, wherein the dynamic scheduling selection is selected at the at least one managed device. The method includes querying, responsive to the at least one managed device being authenticated to the calendar service, the calendar service for available timeframes to deploy at least one object to the at least one managed device. The method includes creating a task window associated with the at least one managed device based on the available timeframes.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. It should be noted that although various aspects may be described herein with reference to healthcare, retail, educational, or corporate settings, these are examples only and are not to be considered limiting. The teachings of the present disclosure may be applied to any mobile device environments, including but not limited to home environments, healthcare environments, retail environments, educational environments, corporate environments, and other appropriate environments. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for creating a task window.

FIG. 2 is a block diagram illustrating the example manager device, at least one managed device, mobile management service, and push notification service from the architecture of FIG. 1 according to certain aspects of the disclosure.

FIG. 3 illustrates an example process for creating a task window depicting the example manager device, first managed device, second managed device, mobile management service, and push notification service of FIG. 2.

FIG. 4 illustrates another example process for creating a task window depicting the example manager device, first managed device, second managed device, mobile management service, and push notification service of FIG. 2.

FIGS. 5A-5J are example illustrations associated with the example processes of FIGS. 3 and 4.

FIG. 6 is block diagram illustrating an example computer system with which the manager device, first managed device, second managed device, mobile management service, and push notification service of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Within various industry organizations, such as in education, for example, there are IT administrators who have direct access, via manager devices, to the mobile device management service for scheduling disruptive tasks to be performed on managed devices that are managed by the mobile device management service. In traditional approaches, the scheduling of the deployment of the disruptive task to the managed devices are entirely configured by the IT administrators at the manager devices without any input from the end users of the managed devices or any granularity into the preferences of each end user. As such, the end users could still be disrupted of use of the managed device during performance of these tasks.

The disclosed technology provides a solution to such traditional approaches. For example, the disclosed technology enables an end user to configure task window settings on the managed device, which are subject to constraints configured by administrators on the manager devices, such that a task window specific to the managed device can be created based on the configured task window settings and the constraints, which a task can be deployed to the managed device during the task window.

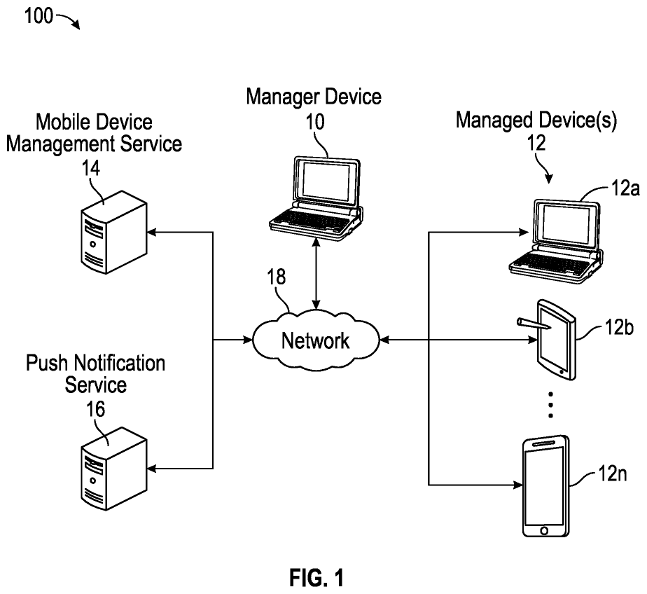

FIG. 1 illustrates an example architecture 100 for creating a task window. For example, the architecture 100 includes a manager device 10, at least one managed device 12, such as a first managed device 12a and a second managed device 12b to an nth managed device 12n, a mobile device management service 14, and a push notification service 16 all connected over a network 18. In certain aspects, the mobile device management service 14 may be connected to the push notification service 16 over a separate network.

The mobile device management service 14 can be any device having an appropriate processor, memory, and communications capability for communicating with the manager device 10, the at least one managed device 12, and the push notification service 16. For purposes of load balancing, the mobile device management service 14 may include multiple servers. The push notification service 16 can be any device having an appropriate processor, memory, and communications capability for communicating with the mobile device management service 14 and the at least one managed device 12. The manager device 10, to which the mobile device management service 14 communicates with over the network 18, can be, for example, a tablet computer, a mobile phone, a mobile computer, a laptop computer, a portable media player, an electronic book (eBook) reader, or any other device having appropriate processor, memory, and communications capabilities. Similarly, the at least one managed device 12, such as the first managed device 12a and the second managed device 12b, to which the mobile device management service 14 communicates with over the network 18 via the push notification service 16, can be, for example, a tablet computer, a mobile phone, a mobile computer, a laptop computer, a portable media player, an electronic book (eBook) reader, or any other device having appropriate processor, memory, and communications capabilities. In certain aspects, the mobile device management service 14 and the push notification service 16 can be a cloud computing server of an infrastructure-as-a-service (IaaS) and be able to support a platform-as-a-service (PaaS) and software-as-a-service (SaaS) services.

It should be noted that although one manager device 10 and two managed devices, such as the first managed device 12a and the second managed device 12b to the nth managed device 12n, are shown in FIG. 1, the present disclosure is not limited to any particular configuration or number of devices. In certain aspects, a different number of manager devices and/or managed devices may be present.

The network 18 can include, for example, any one or more of a personal area network (PAN), a local area network (LAN), a campus area network (CAN), a metropolitan area network (MAN), a wide area network (WAN), a broadband network (BBN), the Internet, and the like. Further, the network 18 can include, but is not limited to, any one or more of the following network topologies, including a bus network, a star network, a ring network, a mesh network, a star-bus network, tree or hierarchical network, and the like.

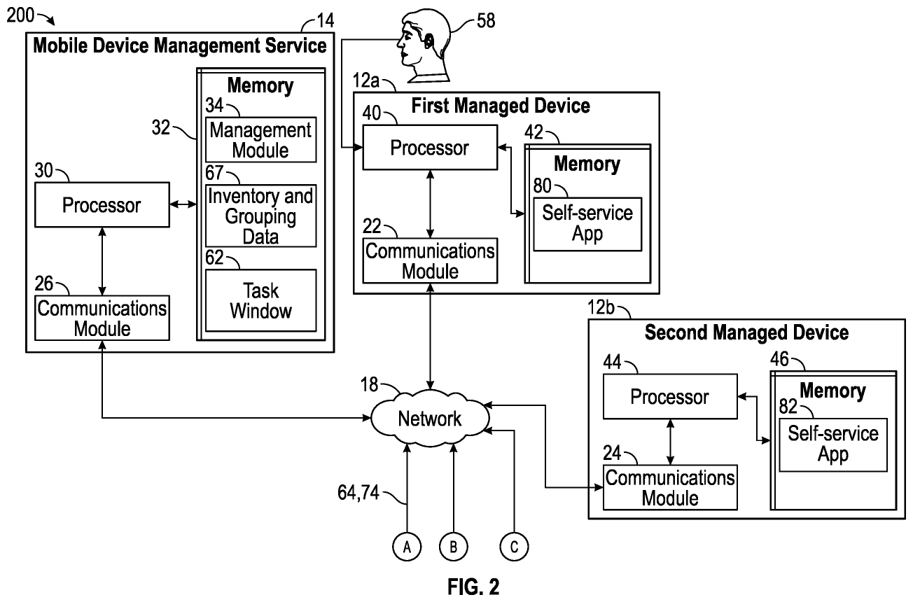

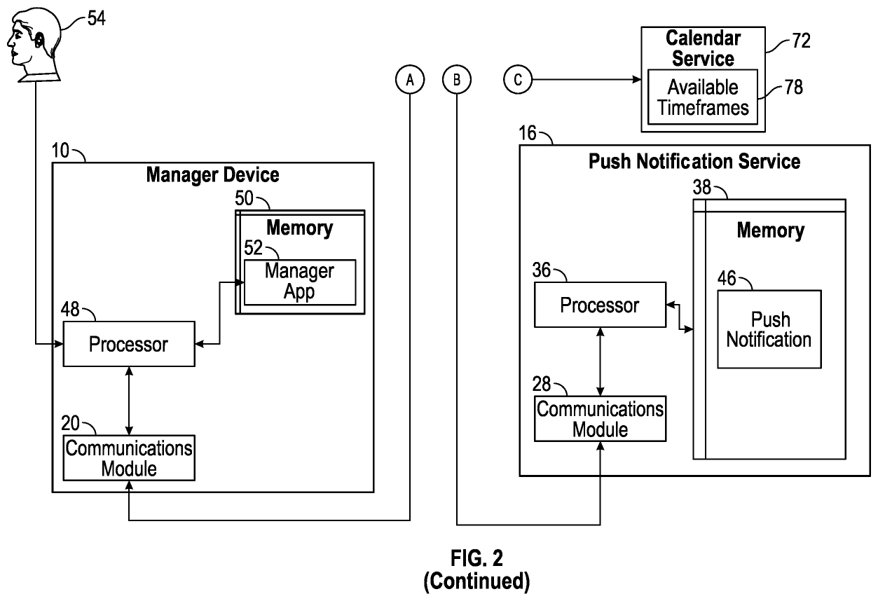

FIG. 2 is a block diagram illustrating examples of the manager device 10, the first managed device 12a, the second managed device 12b, the mobile device management server 14, and the push notification service 16 in the architecture of FIG. 1 according to certain aspects of the disclosure. It should be understood that for purposes of explanation the first managed device 12a and the second managed device 12b are described, but any number of the at least one managed device 12 could be used.

The manager device 10, the first managed device 12a, the second managed device 12b, the mobile device management service 14, and the push notification service 16 are connected over the network 18 via respective communication modules 20, 22, 24, 26, 28. The communication modules 20, 22, 24, 26, 28 are configured to interface with the network 18 to send and receive information, such as data, requests, responses, and commands to other devices on the network 18. The communications modules 20, 22, 24, 26, 28 can be, for example, modems or Ethernet cards.

The mobile device management service 14 includes a processor 30, the communications module 26, and a memory 32 that includes a management module 34. The processor 30 of the mobile device management service 14 is configured to execute instructions, such as instructions physically coded into the processor 30, instructions received from software in the memory 32, or a combination of both. The processor 30 of the mobile device management service 14 is configured to receive from the manager device 10 at least one task availability constraint 56, which is configured at the manager device 10. The processor 30 of the mobile device management service 14 is configured to receive from the at least one managed device 12 task window settings 60, which are configured at the at least one managed device 12. The processor 30 of the mobile device management service 14 is configured to create a task window 62 that is associated with the at least one managed device 12, such that the task window 62 is based on the task window settings 60 configured at the at least one managed device 12 and based on the at least one task availability constraint 56 configured at the manager device 10.

In certain aspects, the processor 30 of the mobile device management service 14 is configured to receive a task command 64 from the manager device 10 to deploy at least one object 66 to the at least one managed device 12 during the task window 62. The processor 30 of the mobile device management service 14 is configured to transmit, based on the task command 64, the at least one object 66 to the at least one managed device 12 during the task window 62.

In certain aspects, the processor 30 of the mobile device management service 14 is configured to cause the manager app 52 on the manager device 10 to display a report 68 based on the task window settings 60 that were configured at the at least one managed device 12.

In certain aspects, the processor 30 of the mobile device management service 14 is configured to cause the manager app 52 on the manager device 10 to display the task window settings 60 that were configured at the first managed device 12a.

In alternative aspects, the processor 30 of the mobile device management service 14 is configured to receive an enablement selection 70 from the manager device 10 to configure integration with a calendar service 72 over the network 18, such that the enablement selection 70 is selected at the manager device 10. The processor 30 of the mobile device management service 14 is configured to receive from the manager device 10 a dynamic scheduling command 74 associated with the enablement selection 70 to configure integration with the calendar service 72. The processor 30 of the mobile device management service 14 is configured to receive from the at least one managed device 12 a dynamic scheduling selection 76, which is selected at the at least one managed device 12. The processor 30 of the mobile device management service 14 is configured to query, responsive to the at least one managed device 12 being authenticated to the calendar service 72, the calendar service 72 for available timeframes 78 to deploy the at least one object 66 to the at least one managed device 12. The processor 30 of the mobile device management service 14 is configured to create the task window 62 associated with the at least one managed device 12 based on the available timeframes 78. The processor 30 of the mobile device management service 14 is configured to receive the task command 64 from the manager device 10 to deploy the at least one object 66 to the at least one managed device 12 during the task window 62. The processor 30 of the mobile device management service 14 is configured to transmit, based on the task command 64, the at least one object 66 to the at least one managed device 12 during the task window 62.

The mobile device management service 14 may correspond to hardware and/or software that implement mobile device management functions. For example, the mobile device management service 14 may manage the at least one managed device 12, such as the first managed device 12a and the second managed device 12b. As such, the mobile device management service 14 may store (or access) inventory and grouping data 67 associated with the at least one managed device 12. The inventory and grouping data 67 may include enrollee data identifying all mobile devices that are managed by the mobile device management service 14, as well as data (e.g., configured task window settings 60) associated with the at least one managed device 12 including the first managed device 12a, and the second managed device 12b to the nth managed device 12n, and grouping information of managed devices within the same designated group.

The push notification service 16 includes a processor 36, the communications module 28, and a memory 38. The processor 36 of the push notification service 16 is configured to execute instructions, such as instructions physically coded into the processor 36, instructions received from software in the memory 38, or a combination of both.

The first managed device 12a includes a processor 40, the communications module 22, and a memory 42 including a first self-service app 80. The processor 40 of the first managed device 12a is configured to execute instructions, such as instructions physically coded into the processor 40, instructions received from software in memory 42, or a combination of both. The first self-service app 80 is configured to receive the task window settings 60 configured via the end user 58 of the first managed device 12a. The task window settings 60 are subject to the at least one task availability constraint 56 configured at the manager device 10 and allow the end user 58 to configure, for example, a time period 84 and/or at least one device state 86, based on the at least one task availability constraint 56, where disruptive tasks, such as maintenance tasks, can be performed on the first managed device 12a. After the task window settings 60 are configured, the first self-service app 80 is configured to transmit the configured task window settings 60 to the mobile device management service 14.

In certain aspects, the first self-service app 80 is configured to receive a dynamic scheduling selection 76 to opt into using dynamic scheduling on the first managed device 12a. In such aspects, in response to receiving the dynamic scheduling selection 76 to opt into using dynamic scheduling, the first self-service app 80 allows, or provides an authentication prompt, for the first managed device 12a to authenticate with a calendar service 72, such that the mobile device management service 14, after the first managed device 12a is authenticated with the calendar service 72, can configure integration (i.e., calendar configuration) with the calendar service 72 to query the calendar service 72 for available timeframes 78 to deploy at least one object 66 to the first managed device 12a.

The second managed device 12b includes a processor 44, the communications module 24, and a memory 46 including a second self-service app 82. The processor 44 of the second managed device 12b is configured to execute instructions, such as instructions physically coded into the processor 44, instructions received from software in memory 46, or a combination of both. The second self-service app 82 is similar to the first self-service app 80 and is configured to perform on the second managed device 12b similar functionalities as described above with respect to the first managed device 12a.

The manager device 10 includes a processor 48, the communications module 20, and a memory 50 that includes a manager app 52. The processor 48 of the manager device 10 is configured to execute instructions, such as instructions physically coded into the processor 48, instructions received from software in memory 50, or a combination of both. The manager app 52 allows an administrative user 54 of the manager device 10 to configure at least one task availability constraint 56 and, after being configured, transmit the at least one task availability constraint 56 to the mobile device management service 14. The at least one task availability constraint 56 are constraints that an end user 58 of the at least one managed device 12, such as the first managed device 12a, must adhere to when the end user 58 configures task window settings 60 on the at least one managed device 12 for a task window 62. After the at least one task availability constraint 56 is configured, the manager app 52 is configured to transmit the configured at least one task availability constraint 56 to the mobile device management service 14.

In certain aspects, the manager app 52 is configured to transmit a task command 64 to the mobile device management service 14 to deploy at least one object 66 to the at least one managed device 12, such as the first managed device 12a and the second managed device 12b. In certain aspects, the manager app 52 is configured to display, on the manager device 10, a report 68 based on the task window settings 60 that were configured at the at least one managed device 12. In certain aspects, the manager app 52 is configured to display, on the manager device 10, the task window settings 60 that were configured at the at least one managed device 12.

It should be noted that although various embodiments may be described herein with reference to healthcare and educational settings, this is for example only and not to be considered limiting. The teachings of the present disclosure may be applied in other mobile device environments, including but not limited to home environments, corporate environments, retail environments, government environments, organization environments, and other well-known environments.

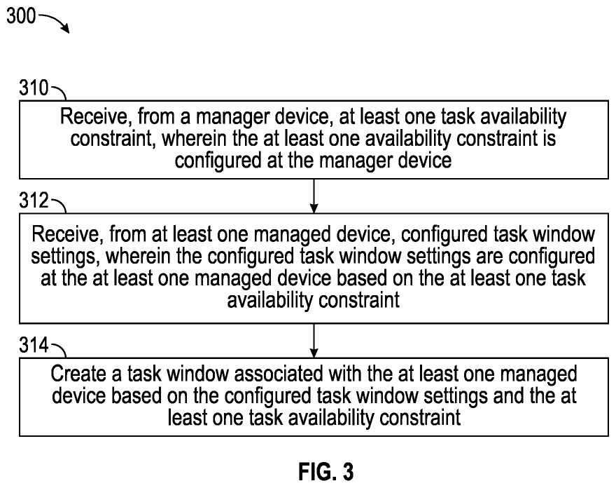

FIG. 3 illustrates an example process 300 using the manager device 10, the first managed device 12a, the mobile device management service 14, and, in certain aspects, the push notification service 16. While FIG. 3 is described with reference to FIG. 2, it should be understood that the process steps of FIG. 3 may be performed by other systems.

The process 300 begins by proceeding to step 310 when the processor 30 of the mobile device management service 14 receives at least one task availability constraint 56 from the manager device 10. The at least one task availability constraint 56 is configured at the manager device 10. As depicted at step 312, the processor 30 of the mobile device management service 14 receives task window settings 60 from the first managed device 12a. The task window settings 60 are configured at the first managed device 12a and are based on the at least one task availability constraint 56. The processor 30 of the mobile device management service 14 creates a task window 62 that is associated with the first managed device 12a, as depicted at step 314, such that the task window 62 is based on the task window settings 60 configured at the first managed device 12a and based on the at least one task availability constraint 56 configured at the manager device 10.

In certain aspects, the processor 30 of the mobile device management service 14 receives a task command 64 from the manager device 10 to deploy at least one object 66 to the first managed device 12a during the task window 62. Based on the task command 64, the processor 30 of the mobile device management service 14 transmits the at least one object 66 to the first managed device 12a during the task window 62.

In certain aspects, the processor 30 of the mobile device management service 14 causes the manager app 52 on the manager device 10 to display a report 68 based on the task window settings 60 that were configured at the first managed device 12a.

In certain aspects, the processor 30 of the mobile device management service 14 causes the manager app 52 on the manager device 10 to display the task window settings 60 that were configured at the first managed device 12a.

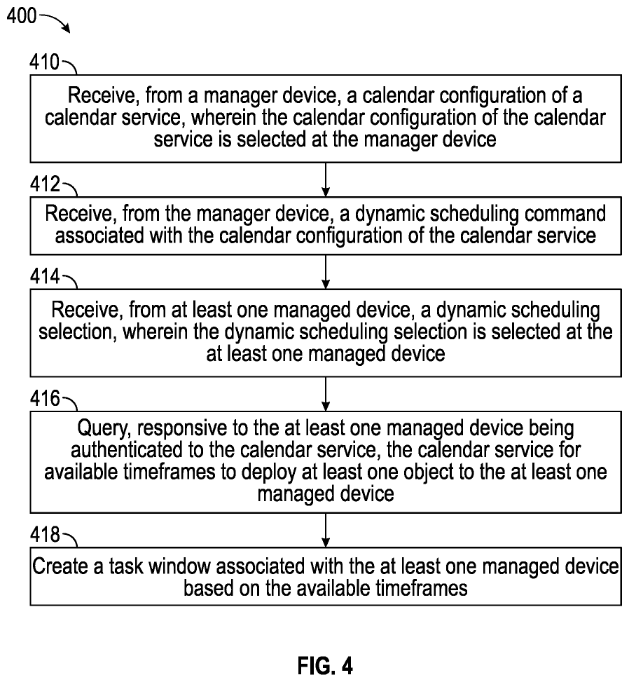

FIG. 4 illustrates another example process 400 using the manager device 10, the first managed device 12a, the mobile device management service 14, and, in certain aspects, the push notification service 16. While FIG. 4 is described with reference to FIG. 2, it should be understood that the process steps of FIG. 4 may be performed by other systems.

The process 400 begins by proceeding to step 410 when the processor 30 of the mobile device management service 14 receives an enablement selection 70 to configure integration with the calendar service 72 from the manager device 10. The enablement selection 70 is selected at the manager device 10. As depicted at step 412, the processor 30 of the mobile device management service 14 receives from the manager device 10 a dynamic scheduling command 74 associated with the enablement selection 70 to configure integration with the calendar service 72. At step 414, the processor 30 of the mobile device management service 14 receives from the first managed device 12a a dynamic scheduling selection 76. The dynamic scheduling selection 76 is selected at the first managed device 12a.

As depicted at step 416, the processor 30 of the mobile device management service 14 queries, responsive to the first managed device 12a being authenticated to the calendar service 72, the calendar service 72 for available timeframes 78 to deploy the at least one object 66 to the first managed device 12a. The processor 30 of the mobile device management service 14 creates the task window 62 associated with the first managed device 12a based on the available timeframes 78, as illustrated at step 418.

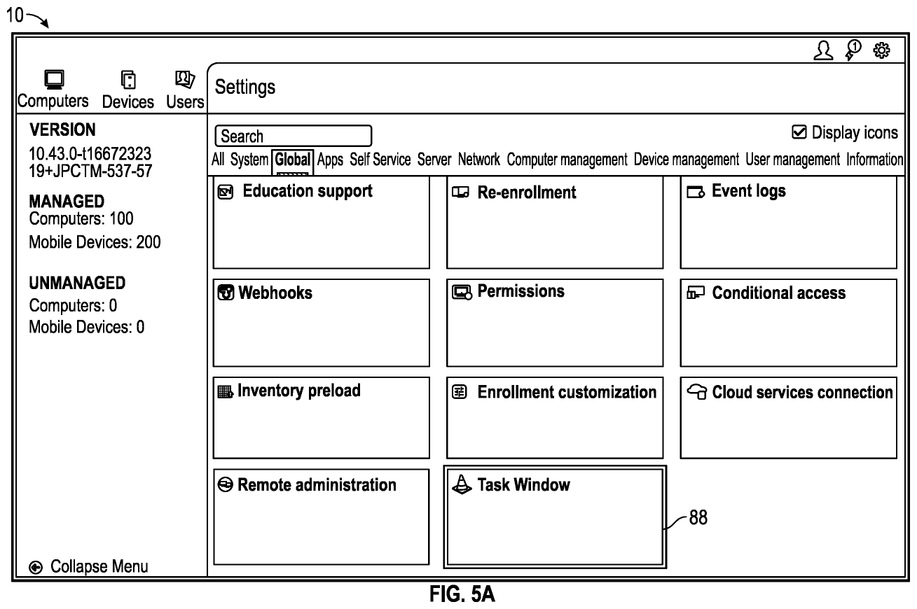

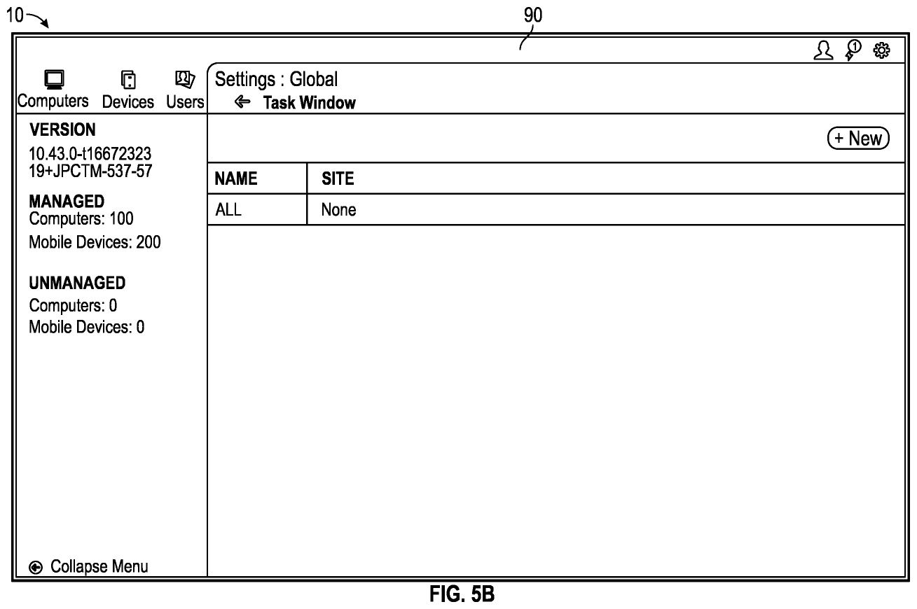

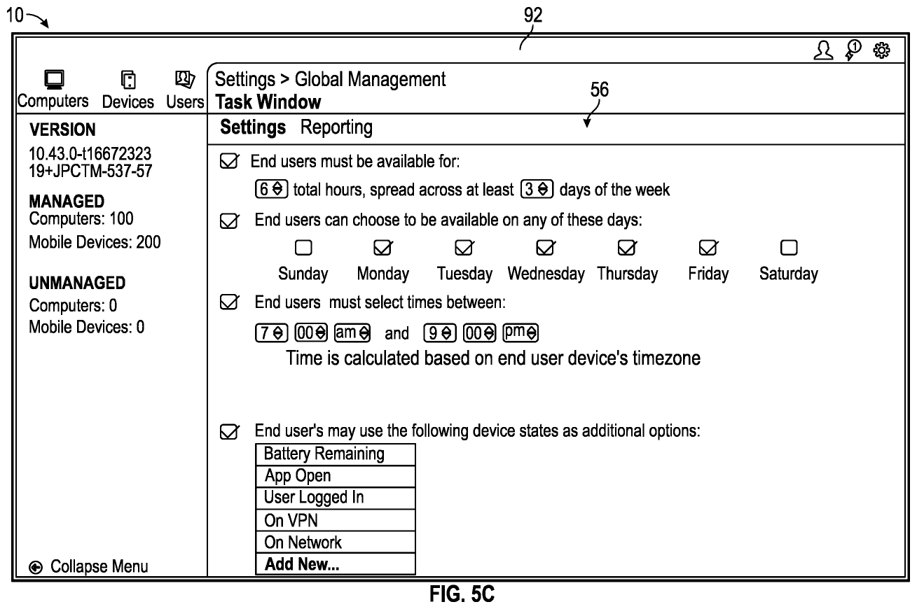

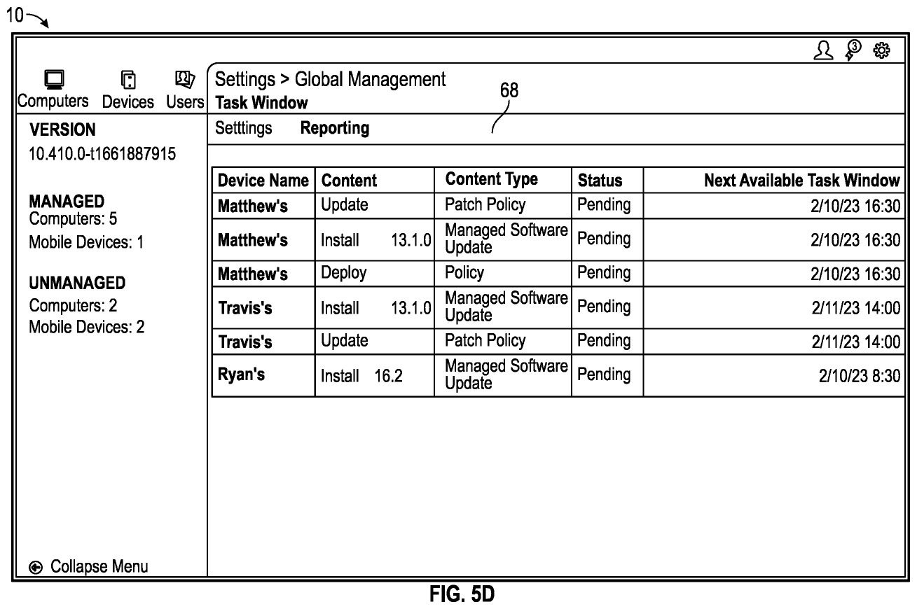

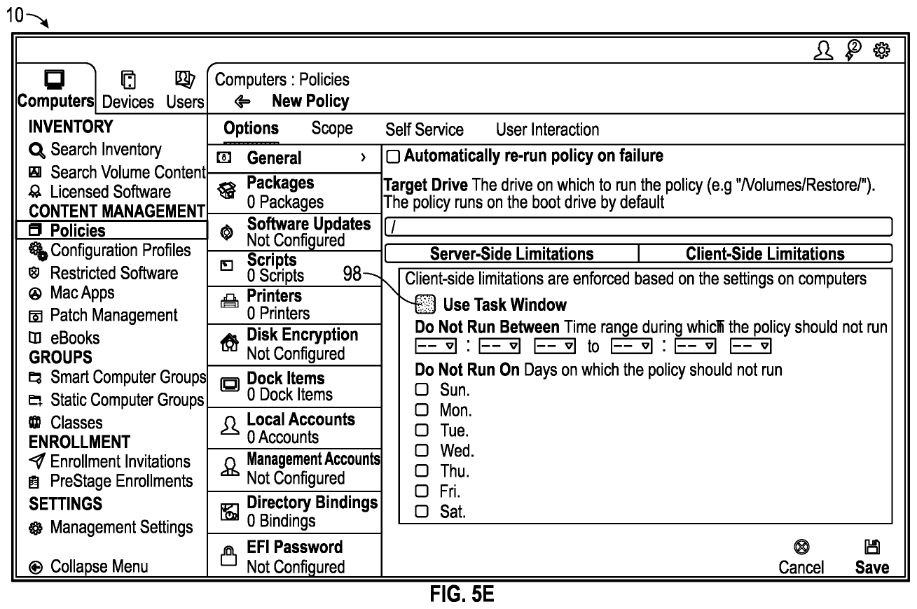

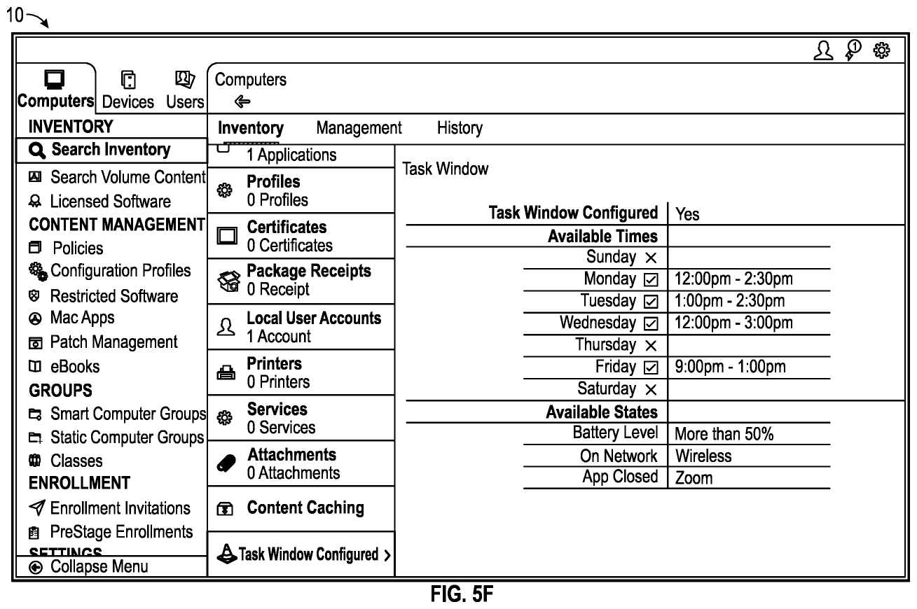

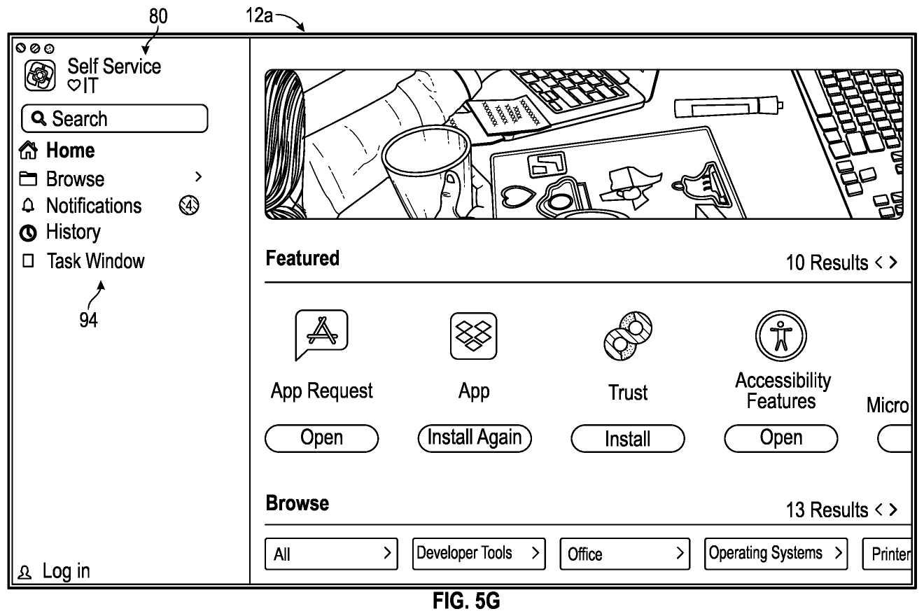

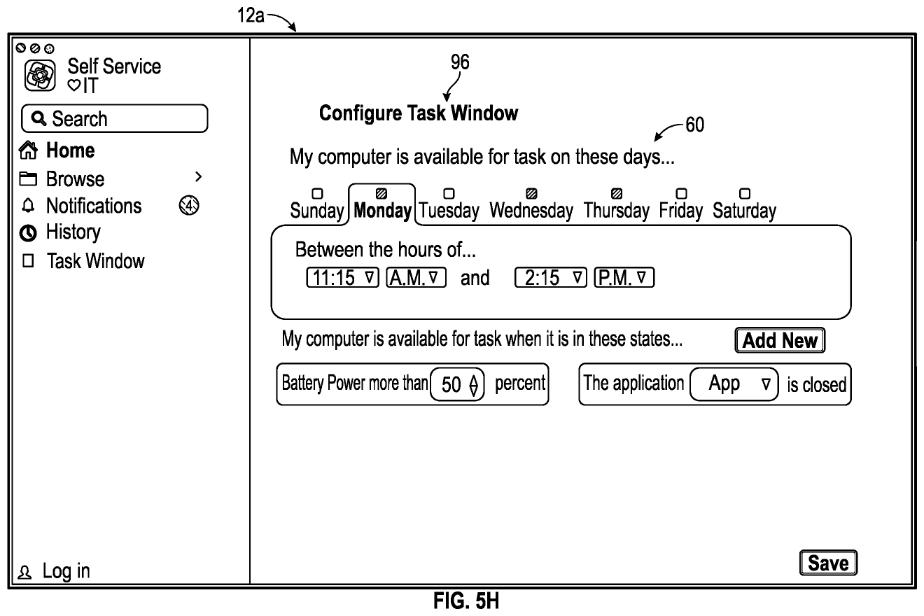

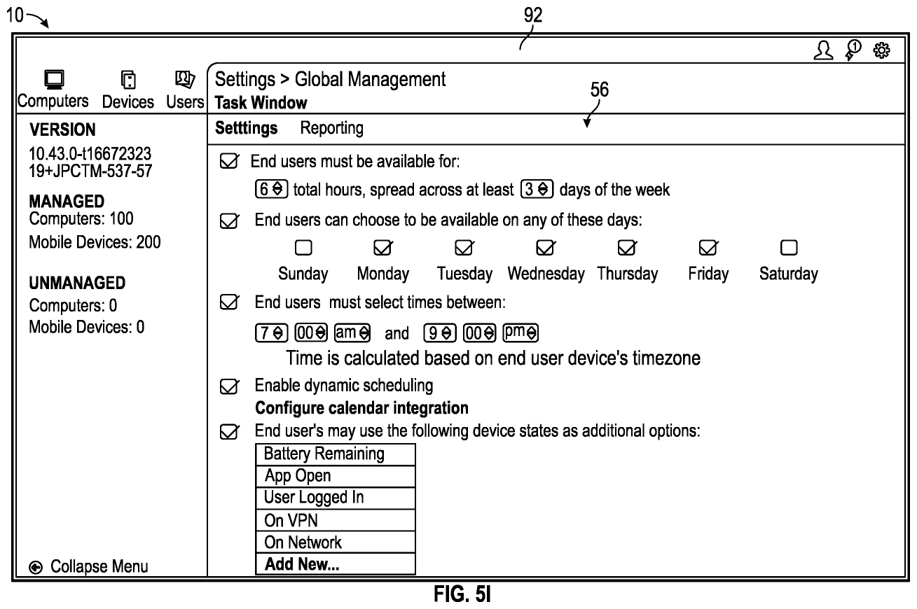

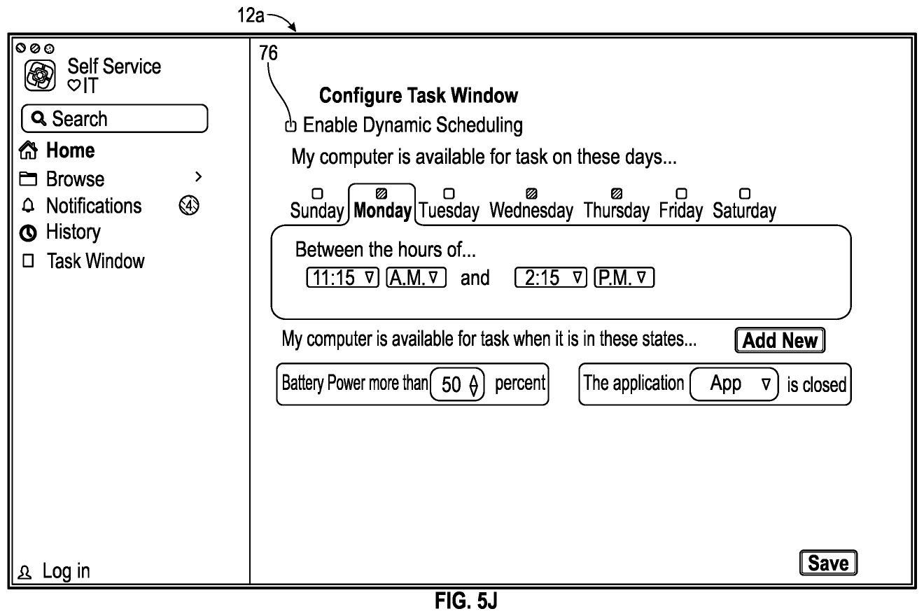

An example will now be described with reference to the example process 300 of FIG. 3, the example process 400 of FIG. 4, and the example figures depicted in FIGS. 5A-5J.

From time to time, the administrative user 54 associated with the manager device 10 may need to initiate disruptive task to be performed on the at least one managed device 12, such as the first managed device 12a and the second managed device 12b, for example. These disruptive tasks may be configured as deployable objects, such as the at least one object 66, and may be, but is not limited to, a managed software update, a policy, a patch policy, an app installer, and any other appropriate deployable object. The administrative user 54 can select a task window item 88 displayed on the manager device 10 via the manager app 52, which will lead to a landing page 90 for allowing configuration of the at least one task availability constraint 56. The at least one task availability constraint 56 are constraints that the end user 58 of the first managed device 12a must adhere to when setting up or configuring the task window settings 60. With particular reference to FIG. 5C illustrating a settings page 92 displayed on the manager device 10, the at least one task availability constraint 56 can include, but is not limited to, available total amount of hours that are spread across a minimum number of days of the week, which days of the week, time period range, managed device state, and any other appropriate constraints. The at least one task availability constraint 56 configured at the managed device 10 are then transmitted to the mobile device management service 14.

With the at least one task availability constraint 56 configuration completed at the manager device 10, the first managed device 12a will be able to configure the task window settings 60 via the first self-service app 80 by, for example, selecting a task window selection 94, as depicted in FIG. 5G. Selection of the task window selection 94 will lead to a task window configuration page 96, as depicted in FIG. 5H, where the end user 58 of the first managed device 12a can configure the task window settings 60, which are constrained by the at least one task availability constraint 56 that was configured at the manager device 10. The task window settings 60 can include, but is not limited to, day selection, time range selection during a selected day, device state (e.g., particular app is closed, battery is charging, Virtual Private Network (VPN) is off, battery power state, an application state, and a connection state, and other suitable device states, etc.). The task window settings 60 that are configured at the first managed device 12a are then transmitted to the mobile device management service 14.

The mobile device management service 14 then creates the task window 62 based on both the at least one task availability constraint 56 that was configured at the manager device 10 and the task window settings 60 that were configured at the first managed device 12a. As illustrated in FIG. 5E, the administrative user 54 selects the task window option 98 via the manager app 52 to deploy the at least one object 66 to the first managed device 12a during the task window 62. Responsive to this selection and designation of the at least one object 66 from the manager device 10, the mobile device management service 14 can transmit the at least one object 66 to the first managed device 12a during the task window 62.

As illustrated in FIG. 5D, the mobile device management service 14, via the manager app 52, can display the report 68 on the manager device 10. The report 68 can show, for example, but not limited to, which managed devices, such as the first managed device 12a and the second managed device 12b, are using a particular task window 62, which of the at least one object 66 are configured to be deployed during the task window 62, deployment status of the at least one object 66, the date/time of a next deployment attempt, and other appropriate information associated with each managed device. As illustrated in FIG. 5F, the manager app 52 can access, via the mobile device management service 14, the inventory and grouping data 67 for the first managed device 12a to display the task window settings 60 that were configured at the first managed device 12a.

With reference to FIGS. 5I and 5J, as an example of an alternative workflow to create the task window 62, in addition to the manager device 10 configuring the at least one task availability constraint 56, the manager device 10 can also configure dynamic scheduling by selecting the enablement selection 70 to configure integration with the calendar service 72. By enabling the enablement selection 70, the dynamic scheduling command 74 is transmitted to the mobile device management service 14 from the manager device 10 such that the first managed device 12a will be allowed to opt into using dynamic scheduling. As such, the end user 58 can select the dynamic scheduling selection 76 on the first managed device 12a, which notifies the mobile device management service 14 that the first managed device 12a has opted into using dynamic scheduling. The first managed device 12a will then be prompted to authenticate with the calendar service 72. After the first managed device 12a is authenticated with the calendar service 72, the mobile device management service 14 is integrated with the calendar service 72 and can query the calendar service 72 for available timeframes 78 to deploy the at least one object 66 to the first managed device 12a. With the available timeframes 78, the mobile device management service 14 creates the task window 62 based on the available timeframes 78. Responsive to the mobile device management service 14 receiving the task command 64 from the manager device 10 to deploy the at least one object 66 to the first managed device 12a, the mobile device management service 14 transmits the at least one object 66 to the first managed device 12a during the task window 62, which is based on the available timeframes 78.

In certain aspects, it should be understood that the push notification service 16 may correspond to one or more network accessible servers that are configured to send push notifications 100 to the at least one managed device 12, such as the first managed device 12a and the second managed device 12b. In some aspects, the push notifications 100 may cause the at least one managed device 12 to check with the mobile device management service 14 to see if there are any commands to be performed by the at least one managed device 12. For example, commands from the mobile device management service 14 may be retrieved by the at least one managed device 12 in response to the push notifications.

Although certain aspects and workflows are described herein with reference to performing mobile device management for a single managed device, it should be understood that mobile device management may also be performed for multiple devices, such as the first managed device 12a and the second managed device 12b to the nth managed device 12n. In certain aspects, for example, the mobile device management service 14 can be configured, via the manager app 52, to allow the manager device 10 to select multiple managed devices or a group of managed devices. A management message may identify multiple managed devices or a group of managed devices of the at least one managed device 12, and the push notification service 16 may send push notifications to each managed device.

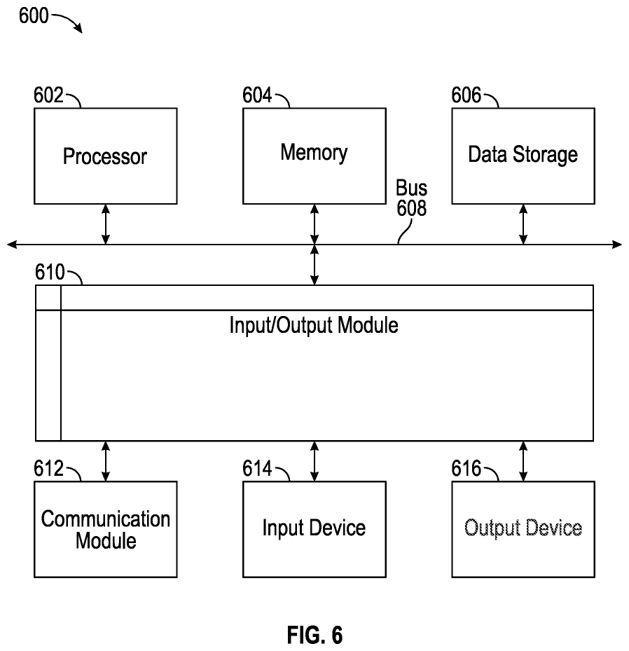

FIG. 6 is a block diagram illustrating an example computer system 600 with which the manager device 10, the first managed device 12a, the second managed device 12b, the mobile device management service 14, and the push notification service 16 of FIG. 2 can be implemented. In certain aspects, the computer system 600 may be implemented using hardware or a combination of software and hardware, either in a dedicated server, or integrated into another entity, or distributed across multiple entities.

Computer system 600 (e.g., the manager device 10, the first managed device 12a, the second managed device 12b, the mobile device management service 14, and the push notification service 16) includes a bus 608 or other communication mechanism for communicating information, and a processor 602 (e.g., the processor 30, 36, 40, 44, 48) coupled with bus 608 for processing information. According to one aspect, the computer system 600 can be a cloud computing server of an IaaS that is able to support PaaS and SaaS services.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., the memory 32, 38, 42, 46, 50), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer readable medium for execution by, or to control the operation of, the computer system 600.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Example input/output modules 610 include data ports such as USB ports. In addition, input/output module 610 may be provided in communication with processor 602, so as to enable near area communication of computer system 600 with other devices. The input/output module 610 may provide, for example, for wired communication in some implementations, or for wireless communication in other implementations, and multiple interfaces may also be used. The input/output module 610 is configured to connect to a communications module 612. Example communications modules 612 (e.g., the communications module 20, 22, 24, 26, 28) include networking interface cards, such as Ethernet cards and modems.

In certain aspects, the input/output module 610 is configured to connect to a plurality of devices, such as an input device 614 and/or an output device 616. Example input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device.

According to one aspect of the present disclosure the manager device 10, the first managed device 12a, the second managed device 12b, the mobile device management service 14, and the push notification service 16 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. Processor 602 may process the executable instructions and/or data structures by remotely accessing the computer program product, for example by downloading the executable instructions and/or data structures from a remote server through communications module 612 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 602 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 608. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
receiving, from a manager device, at least one task availability constraint, wherein the at least one availability constraint is configured at the manager device;
receiving, from at least one managed device, configured task window settings, wherein the configured task window settings are configured at the at least one managed device based on the at least one task availability constraint; and
creating a task window associated with the at least one managed device based on the configured task window settings and the at least one task availability constraint.

2. The computer-implemented method of claim 1, further comprising:
receiving, from the manager device, a task command to deploy at least one object to the at least one managed device during the task window; and
transmitting, based on the task command, the at least one object to the at least one managed device during the task window.

3. The computer-implemented method of claim 1, further comprising:
displaying, on the manager device, a report based on the configured task window settings associated with the at least one managed device.

4. The computer-implemented method of claim 1, further comprising:
displaying, on the manager device, the configured task window settings associated with the at least one managed device.

5. The computer-implemented method claim 1, wherein the configured task window settings comprise a time period and at least one device state of the at least one managed device.

6. The computer-implemented method of claim 5, wherein the at least one device state comprises a battery power state, an application state, and a connection state.

7. A system comprising:
a memory comprising instructions; and
a processor configured to execute the instructions which, when executed, cause the processor to:
receive, from a manager device, at least one task availability constraint, wherein the at least one task availability constraint is configured at the manager device;
receive, from at least one managed device, configured task window settings, wherein the configured task window settings are configured at the at least one managed device based on the at least one task availability constraint; and
create a task window associated with the at least one managed device based on the configured task window settings and the at least one task availability constraint.

8. The system of claim 7, further comprising instructions to cause the processor to:
receive, from the manager device, a task command to deploy at least one object to the at least one managed device during the task window; and
transmit, based on the task command, the at least one object to the at least one managed device during the task window.

9. The system of claim 7, further comprising instructions to cause the processor to:
display, on the manager device, a report based on the configured task window settings associated with the at least one managed device.

10. The system of claim 7, further comprising:
display, on the manager device, the configured task window settings associated with the at least one managed device.

11. The system of claim 7, wherein the configured task window settings comprise a time period and at least one device state of the at least one managed device.

12. The system of claim 11, wherein the at least one device state comprises one of a battery power state, an application state, and a connection state.

13. A non-transitory machine-readable storage medium comprising machine-readable instructions for causing a processor to execute a method, the method comprising:
receiving, from a manager device, at least one task availability constraint, wherein the at least one task availability constraint is configured at the manager device;
receiving, from at least one managed device, configured task window settings, wherein the configured task window settings are configured at the at least one managed device based on the at least one task availability constraint; and
creating a task window associated with the at least one managed device based on the configured task window settings and the at least one task availability constraint.

14. The non-transitory machine-readable storage medium of claim 13, further including instructions for causing the processor to execute the method comprising:
receiving, from the manager device, a task command to deploy at least one object to the at least one managed device during the task window; and
transmitting, based on the task command, the at least one object to the at least one managed device during the task window.

15. The non-transitory machine-readable storage medium of claim 13, further including instructions for causing the processor to execute the method comprising:
displaying, on the manager device, a report based on the configured task window settings associated with the at least one managed device.

16. The non-transitory machine-readable storage medium of claim 13, further including instructions for causing the processor to execute the method comprising:
displaying, on the manager device, the configured task window settings associated with the at least one managed device.

17. The non-transitory machine-readable storage medium of claim 13, wherein the configured task window settings comprise a time period and at least one device state of the at least one managed device.

18. The non-transitory machine-readable storage medium of claim 17, wherein the at least one device state comprises one of a battery power state, an application state, and a connection state.

19. A computer-implemented method comprising:
receiving, from a manager device, a calendar configuration of a calendar service, wherein the calendar configuration of the calendar service is selected at the manager device;
receiving, from the manager device, a dynamic scheduling command associated with the calendar configuration of the calendar service;
receiving, from at least one managed device, a dynamic scheduling selection, wherein the dynamic scheduling selection is selected at the at least one managed device;
querying, responsive to the at least one managed device being authenticated to the calendar service, the calendar service for available timeframes to deploy at least one object to the at least one managed device; and
creating a task window associated with the at least one managed device based on the available timeframes.

20. The computer-implemented method of claim 19, further comprising:
receiving, from the manager device, a task command to deploy the at least one object to the at least one managed device during the task window; and
transmitting, based on the task command, the at least one object to the at least one managed device during the task window.
